(19) United States
(12) Patent Application Publication
(10) Pub. No.: US 2013/0076870 A1
(43) Pub. Date: Mar. 28, 2013

(54) Stereoscopic 3D Camera

(71) Applicant: 3DIP, LTD., London (GB)

(72) Inventors: Jonathan R. Kitzen, St. John's (CA); Matthew Stephen Whalen, San Clemente, CA (US); Roger Thomas Thorpe, Irvine, CA (US)

(73) Assignee: 3DIP, LTD., London (GB)

(21) Appl. No.: 13/680,803

(22) Filed: Nov. 19, 2012

Related U.S. Application Data
(63) Continuation of application No. 13/439,834, filed on Apr. 4, 2012, now abandoned.
(60) Provisional application No. 61/471,211, filed on Apr. 4, 2011.
(60) Provisional application No. 61/471,689, filed on Apr. 4, 2011.
(60) Provisional application No. 61/472,185, filed on Apr. 5, 2011.

(51) Int. Cl. H04N 13/02

(52) U.S. Cl. CPC H04N 13/0207
USPC 348/49

(57) ABSTRACT

A stereoscopic 3D camera that utilizes a single set of electronics to power and control two sensor/lens modules. The camera will be optically designed to mimic the human eye, including the ability to converge upon an object of interest while rotating about the nodal point of the lens/sensor module. The system as a whole will be modular and lightweight, with field changeable lens/sensor assemblies. Camera functions are controlled via multiple remote controls allowing multiple operators to simultaneously control their allocated tasks.

### RELATED APPLICATIONS

The present application is a continuation of U.S. patent application Ser. No. 13/439,834, filed on Apr. 4, 2012, which claims the benefit of priority under 35 USC §119(e) to U.S. Provisional Application No. 61/471,211, filed on Apr. 4, 2011; to U.S. Provisional Application No. 61/471,689, filed on Apr. 4, 2011; and to U.S. Provisional Application No. 61/472,185, filed on Apr. 5, 2011, which are incorporated herein by reference.

### BACKGROUND OF THE INVENTION

1. Field of the Invention

The present invention is in the field of software-based design tools for creating integrated circuits having active components operating in the electromagnetic fields of high frequency transmission signals.

2. Description of Related Art

The current level of stereoscopic camera design makes use of two discrete camera systems loosely coupled together to capture pairs of images. Extensive post processing is often required to present the two images to the viewer in a manner that his or her brain can mesh into an integrated 3D image.

Such systems are assembled in a specially constructed frame that mounts the two discrete cameras for stereoscopic use, thus they are at least twice as heavy as a single 2D camera, often weighing over 150 pounds. This is clearly too heavy for easy mobile use.

Image sensors on such units are not precisely matched and operate inconsistently causing differences in performance (i.e. differing color balance levels). Unmatched optical components also tend to cause unpleasant physical side effects for users, such as nausea and headaches. This is a direct result of the brain trying to correct differences in a multitude of visual factors, such as image size and position, at 30-60 Hz/sec.

Current stereoscopic 3D systems lack modular functionality and the optics of a system cannot be changed in the field. This creates a cumbersome and unwieldy system that is generally unsuitable for many film settings. Such systems require long setup times between each shoot. Most systems are not robust and cannot easily retain alignment of sensors and lenses nor are they symmetrical and cannot be used with a Steadicam system.

When two cameras are used, no common data stream is generated. Thus, additional processing power must be used to merge the two data streams before any post processing occurs. Existing systems do not support complete 3D meta-data, specifically inter-axial distance and convergence angle.

Existing systems are limited in the types of lenses supported by the systems. For example, existing systems often do not support wide-angle lenses. The demand for high resolution systems cannot be adequately met with the current level of technology as most systems cannot support high performance sensors up to 4K.

Traditional cameras have one or more audio inputs that require all audio feeds to be sent to the camera prior to them being recorded with the video signal. The embedded audio then plays back with the video for synchronous playback. Synchronization between camera and discreet audio recorded separately from the camera is obtained by creating a synchronous visual/audio cue such as film slate clap, or by means of electronic time-code by which both camera and audio recorder share the same time-code numbers often via direct connection or via “jam synch” whereby both camera and audio recorder are preloaded with time code numbers by means of a short term connection to establish synch numbers for internal time code generators.

### SUMMARY OF THE INVENTION

The present invention is a built from the ground up stereoscopic 3D imaging system that utilizes a single set of electronics to power and control two lens/sensor assemblies. The system is designed to be lightweight, modular and portable. Depending upon accessories and attachments it weighs approximately 15-20 lbs.

The system is designed to function in a manner similar to the human eye. Precisely matched sensor and lens pairs aligned to a high degree of precision will be used to eliminate unpleasant visual side-effects, such as headaches and nausea, users may experience. Precision matched lens/sensors will also greatly reduce or eliminate the need for post processing image corrections.

The present invention is designed to be modular in nature. The body of the camera will be covered with a proprietary mounting system based upon the STANAG 4694 NATO accessory rail. The camera head unit housing the lenses, sensors and servos comprise a detachable module from the camera body and can be changed quickly in the field for other head units and allows for a wide variety of sensor and lens types to be quickly attached to the camera system. Similarly, a variety of camera backs are provided that can be changed in the field. A standard back module provides the interconnections to external storage devices, monitors, power supplies etc. A data-back module also comprises a removable storage module that can be used for local storage. This provides two important capabilities. One the ability to be untethered and two the ability to record at very high-speed which is not possible over the standard interfaces used when tethered to an external storage device.

All opto-mechanical features of the camera system are controlled by a common mechanism in order to ensure that the optics track accurately to a high degree of precision. In addition, the camera system will compile extensive Meta Data including 3D parameters. Meta data will be used during editing to ensure accurate 3D images are supplied.

The Meduza 3D1 stereoscopic camera system includes a unique lens mount. Traditional lens mounts apply torque moments and other physical stresses to the camera body when a lens is removed or attached. The unique “Kenji mount” developed for this system places all of these stresses on the lens which is being held by the user. This helps ensure that the alignment of the 3D optical system is not compromised by the replacement of a lens. This is especially important in-the-field.

The Meduza 3D1 stereoscopic camera system supports a wide variety of sensors. The limiting factors are for image bandwidth and power consumption. The Head units are designed so that new sensors can be readily adopted without a system redesign. To do this the sensor image output streams are run through a sensor control module that converts whatever data format is presented by the image sensor into a common pixel data format. This format is modular and can handle a bandwidth of up to 100 Gbits/sec per sensor in the current generation. The modularity allows for low cost lower performance sensors to be used with low cost sensor control module FPGAs and retain full compatibility with the rest of the system. Adoption of a new sensor is accommodated by a new carrier PCB that adapts the sensor to the carrier modules (“eyes”) and by new firmware for the Sensor Control Module FPGA that is written to describe the conversion of the interface formats.

There is no fundamental restriction as to the number of sensors/lens assemblies that a Head unit supports. Normal 2D heads with a single sensor are as viable as heads with 5 sensor/lens units.

The lens/sensor assemblies, called camera “eyes”, are attached to and move along an inter-axial rail. Motors are employed within the system, one to adjust the inter-axial (inter-ocular) distance and the one motor each to control the convergence angle of each camera eye. Within the eye modules are further motors to control the lens functions focus, iris and when appropriate zoom.

Lens settings are simultaneously adjusted, including the focus, iris, zoom, inter-axial distance and convergence angle. In the case of convergence angle adjustment, it is helpful to think of one lens “mirroring” the other (i.e. one head rotates left, the other right). In order to optimize all these functions and maintain accuracy down to the single pixel level the 3D1 camera system uses image processing techniques to create error signals that are used to help the servos systems maintain correct registration of the desired settings.

A typical camera system requires a number of different operators, each with different responsibilities. There is usually a cinematographer, an assistant cinematographer, a focus puller, a stereographer, as well as a director, all of which need to control different camera functions. Currently these operations have to be done sequentially and can take considerable time as the adjustments from one operator may affect the adjustments of another and multiple corrections may be necessary.

The Meduza 3D1 camera system provides a dynamic control and registration system in order to allow multiple camera functions to be performed simultaneously, even if these commands come from different users. This mechanism is performed via one or more wireless remote controls. Conflicts will undoubtedly occur as multiple users have access to the same control function. A system to resolve conflicts is integrated into the wireless control system. The rules by which the conflict resolution system functions are arbitrary and user programmable.

The camera may also be attached to secondary systems, for example a remote storage device that must also be controlled by the multiple remote controllers. The camera must then act as a “clearing house” for the commands and control which actions require control of the secondary systems and pass-on appropriate commands. For example, in the case of the remote storage device, typical commands are Start, Stop, Record, Erase and Playback.

Having gone to great lengths to ensure the best attainable image quality from the image sensors, no further processing or compression is performed by the camera system. This again is done to retain as high an image quality as possible. This requires a storage system that can store the RAW image data from the image sensors at a wide range of data rates based on the sensor resolution and frame rate. The 3D1 camera system can be equipped with an attached storage system capable of storing up to 100 Gbits/s to FLASH memory. The current density of NAND FLASH devices allows for a recording time around 4 minutes of high definition 1,000 frames per second video.

The camera is equipped with a complete positioning system that allows the precise location and orientation of the camera to be known at all times. GPS is used for base position and universal time-code and is augmented with 3-axis gyroscope, 3-axis accelerometer, 3-axis magnetometer, a barometer and a thermometer. This information is stored as metadata along with video whenever recording takes place. As such camera systems are often leased equipment and the location information can be reported back to a leasing agent or other supervisor. This is accomplished either via internet access if possible or via GSM cellular telephone built-in to the camera. For very remote use, an interface is also provided to an external satellite phone system. As a security measure, the system can be set up to require regular check-ins to the supervisor system. If the camera does not check-in, the camera will shut down and prevent further recording, which effectively renders the camera inoperable. This is done using rolling-code security keys similar to common garage-door openers. On a regular time-interval the camera “checks-in” and receives a new key code. If no new key code is received, because the camera failed to “check-in” for any reason then the camera shuts down. It is also capable of receiving, over the same system, a new key that will re-enable full system functionality. This allows the lessor to control the use and operation of the camera system if so desired.

### BRIEF DESCRIPTION OF THE DRAWINGS

Embodiments in accordance with aspects of the present invention are described below in connection with the attached drawings in which:

FIG. 1 illustrates a front perspective view of a 3D camera that incorporates an embodiment of the mounting system in accordance with embodiments of the invention;

FIG. 2 illustrates a rear perspective view of the 3D camera of FIG. 1;

FIG. 3 illustrates a front perspective view of the 3D camera of FIG. 1 with the lens mounting subsystem shown in more detail;

FIG. 4 illustrates a block diagram of convergence control electronics for controlling the lens mounting subsystem of FIG. 3;

FIG. 5 illustrates the apparent sizes of objects in the foreground, the mid-ground and the background for mono-ocular vision;

FIG. 6 illustrates a representation of the same objects of FIG. 5, as seen in a stereo vision binocular system;

FIG. 7 illustrates the placements of regions-of-interest to determine the apparent separation of the objects of FIG. 6; and

FIG. 8 illustrates the trigonometric relationship between the convergence angles and inter-axial distances of three configurations of stereoscopic imaging assemblies.

### DETAILED DESCRIPTION OF PREFERRED EMBODIMENTS

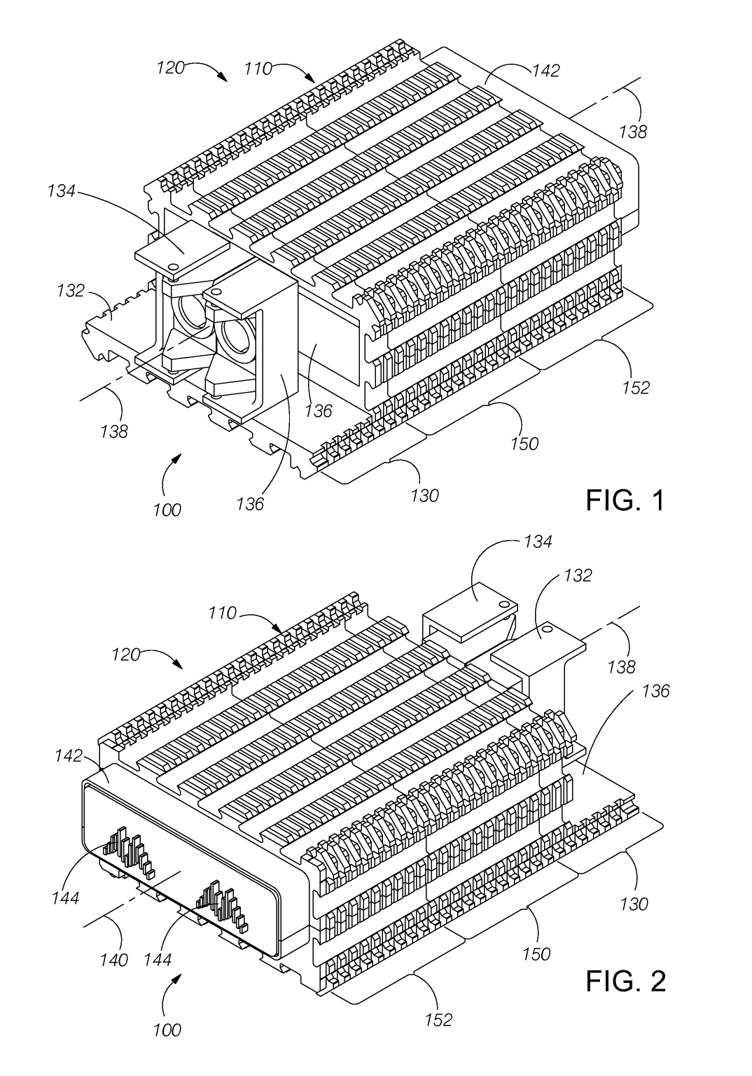

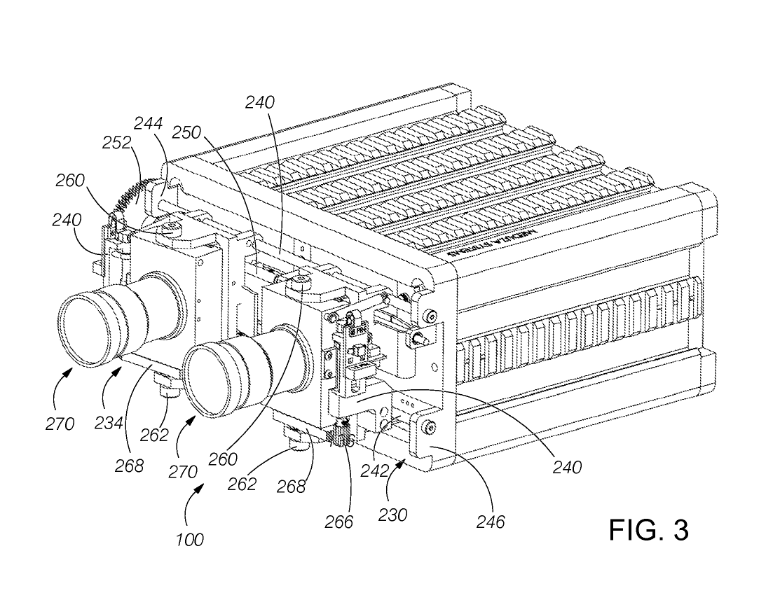

FIGS. 1 and 2 illustrate front and rear perspective views, respectively, of a 3D camera system 100 that incorporates a universal rail mounting system 110 as part of an enclosure 120 of the 3D camera system. As illustrated, the front of the 3D camera system includes a lens mounting subsystem 130 having an extended lower support platform 132 that supports a first lens assembly 134 and a second lens assembly 136. The two lens assemblies are mounted to a positioning assembly 138 that is controllable to vary the distance between the two lens assemblies about a centerline 140. Each lens assembly is further positionable to vary the angle of the lens assembly with respect to the centerline to adjust the focal point. The lenses within each lens assembly are adjustable with respect to at least the aperture and the focal length. Each lens assembly includes a photodetector array that receives a respective image and generates an electronic representation of the image. An electronics subsystem (not shown) is housed within the enclosure. The electronics subsystem controls the lens mounting subsystem, controls the two lens assemblies and processes the electronic representations of the images. In FIG. 1, the lens mounting subsystem is only shown schematically. Additional details are illustrated in FIG. 3.

As illustrated schematically in FIG. 2, various connectors 144 are housed within a rear portion 142 of the enclosure 120 to communicate with the electronics subsystem.

In the illustrated embodiment, the enclosure 120 comprises a first enclosure shell 150 and a second enclosure shell 152. The two enclosure shells may be identical as shown. Accordingly, the first enclosure shell is illustrated in more detail in FIGS. 3-9, and it is understood that in the illustrated embodiment, the second enclosure shell has a similar construction. As discussed below, the first enclosure shell receives the lens mounting subsystem 130 in a recess in a front portion of the first enclosure shell. The rear portion of the first enclosure shell nests within a corresponding recess in the front portion of the second enclosure shell. The rear portion of the second enclosure shell houses the connectors 144 and corresponds to the rear portion 142 of the enclosure.

FIG. 3 illustrates a modified enclosure 220 that supports an alternative configuration of a lens mounting subsystem 230, which supports a first (right) lens assembly 234 and a second (left) lens assembly 236. The first and second lens assemblies are supported by an upper horizontal guide rail 240 and a lower horizontal guide rail 242. Each guide rail is supported at a respective right end by a right support bracket 244 and at a respective left end by a respective left support bracket 246. As used herein, “left” and “right” are referenced to the positions of the two lens assemblies when looking from the back of the enclosure towards the front of the enclosure. Accordingly, in the view in FIG. 3, which faces towards the fronts of the lens assemblies, the right lens assembly is on the left in the drawing, and the left lens assembly is on the right.

The two lens assemblies 234, 236 are movable horizontally along the upper and lower guide rails 240, 242. The horizontal movement of the two lens assemblies is controlled by a double-threaded screw 250. The right half of the double-threaded screw is formed with a conventional right hand thread that engages a threaded recess (not shown) at the rear of the right lens assembly. The left half of the double-threaded screw is formed with a left hand thread that engages a threaded recess (not shown) at the rear of the left lens assembly. The double-threaded screw is driven by a gear 252 that is driven by a lens spacing motor (not shown). When the motor turns the gear in a first rotational direction, the double-threaded screw causes the right lens assembly to move towards the right and causes the left lens assembly to move towards the left, thus causing the two lens assemblies to move farther apart away from the center of the front of the lens mounting assembly 230. When the motor turns the gear in a second rotational direction opposite the first rotational direction, the right lens assembly moves toward the left and the left lens assembly moves toward the right, thus causing the two lens assemblies to move towards each other at the center of the lens mounting assembly. When initially mounted on the double-threaded screw, the two lens assemblies are accurately positioned by substantially equal distances from the center of the lens mounting assembly. Accordingly, regardless of the direction of movement caused by the rotation of the gear, the two lens assemblies will always be positioned by substantially the same distance from the center of the lens mounting assembly.

As further shown in FIG. 3, each lens mounting assembly 234, 236 pivots about a respective vertical axis defined by a respective upper mounting bearing 260 and a respective lower mounting bracket 262. The lens mounting assemblies are caused to pivot about the respective axes by a respective convergence motor assembly 264 having an output gear 266 that drives a respective pivot gear 268 centered on the respective vertical axis of each lens mounting assembly. (The output gear for the right lens mounting assembly is hidden in FIG. 3.)

Each lens mounting assembly 234, 236 supports a removable lens 270. Each lens is mounted in the respective lens mounting assembly by a low-torque threaded mounting interface. Each lens is electronically controlled in a conventional fashion to vary the focal length and the opening of the aperture. In preferred embodiments, the lens in the right lens assembly and the lens in the left lens assembly are manufactured as pairs that include optics that are selected to match so that the images produced by the left lens assembly and the right lens assembly are precisely matched.

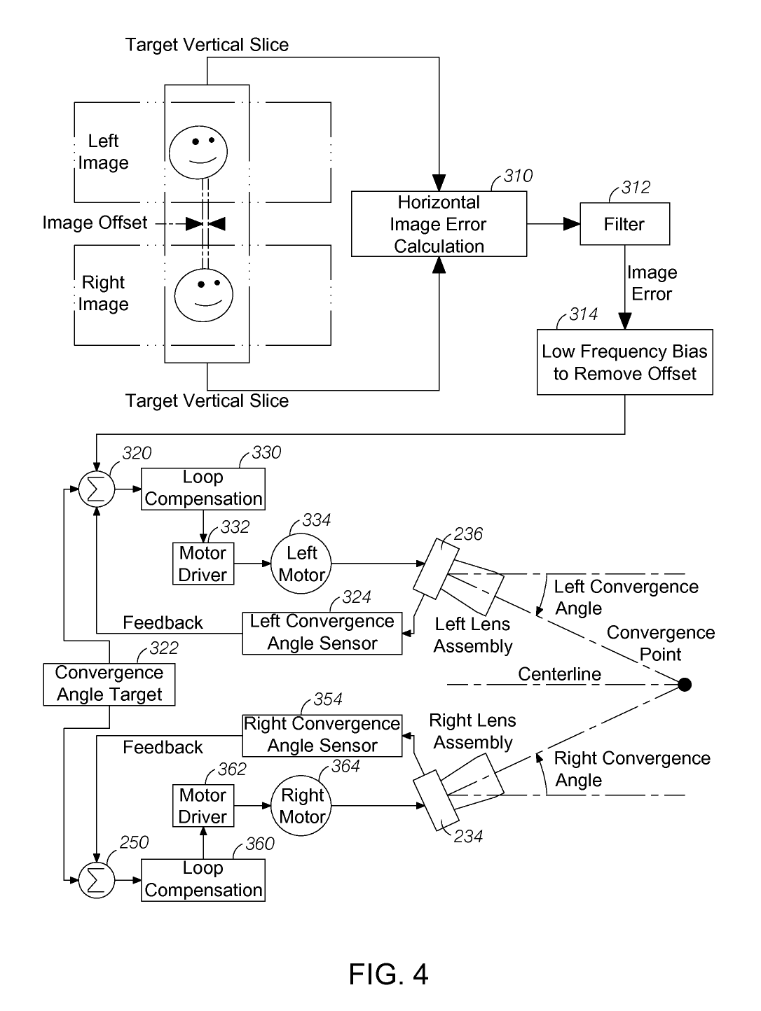

The enclosure 120 houses electronic circuitry that controls the convergence of the two lens assemblies. The convergence control electronics, represented by a block diagram in FIG. 4, provides an improved method of aligning lenses in a 3D camera. The right lens assembly 234 and the left lens assembly 236 and their respective convergence motor assemblies 264 are represented pictorially in FIG. 4. The lens assemblies collect images on respective CCD arrays (not shown), and the digitized images are provided to the image processor. When the images are focused on the same target, the two images should be substantially the same within the middle of the image. As the distance to the image varies, the angle between the two lens assemblies varies so that the images from the two lenses converge at the target location. The angle to which a lens is set is noted as the Convergence Angle. When properly converged, the convergence angles of the two lens assemblies should be substantially the same relative to the centerline of the lens mount system 130.

In FIG. 4, the images produced by respective target slice proximate to the centers of the left and right images are shown at the top. The digital outputs of the lenses corresponding to the target slices are provided as inputs to a horizontal image error calculation block 310, which produces a horizontal error value. That value is filtered in a block 312 and a low frequency bias is applied in block 314 to remove the offset between the two images. The resulting value is provided as one input to a left summing circuit 320. The left summing circuit also receives a target convergence angle from a block 322 and a feedback signal from a left convergence angle sensor 324. The left summing circuit generates a difference signal that is provided as an input to a left loop compensation circuit 330. The loop compensation circuit is optimized to ensure loop stability as well as performance characteristics of the left lens control circuitry. The left loop compensation circuit generates an output signal that controls a left motor drive 332, which controls the operation of a convergence motor 334 in the left lens assembly. The convergence angle of the left lens assembly is measured by the left convergence angle sensor, which generates the feedback signal to the left summing circuit, as discussed above.

In the illustrated embodiment, the right lens assembly 234 is controlled in a similar manner by corresponding right control circuitry. In particular, the right control circuitry includes a right summing circuit 350. In the illustrated embodiment, the right summing circuit also receives a target convergence angle from the block 322 and receives a feedback signal from a right convergence angle sensor 354. The right summing circuit generates a difference signal that is provided as an input to a right loop compensation circuit 330. The right loop compensation circuit is also optimized to ensure loop stability. The right loop compensation circuit generates an output signal that controls a right motor drive 362, which controls the operation of the convergence motor in the right lens assembly. The convergence angle of the right lens assembly is measured by the right convergence angle sensor, which generates the feedback signal to the right summing circuit, as discussed above.

The convergence circuitry in FIG. 4 implements an image processing method that creates the error offsets that are used by the servo control systems by which the two lens assemblies maintain convergence and optical alignment upon a common Region of Interest (ROI). This is analogous to human binocular vision in which the left and right eyes are capable of tracking moving objects in their respective field of view to produce a single 3D image.

Both lens assemblies are placed upon a mechanical system that will allow translation and rotation. The translation of the lens assemblies is linear and varies the distance between the optical centers of the two lens assemblies. This distance is referred to herein as the inter-axial distance (analogous to the inter-ocular distance between human eyes). The rotation is the toe-in of the two lens assemblies such that they converge upon a common point in space (ROI) in front of the camera. This facilitates alignment to the convergence point by providing a direct connection between the two lens assemblies. The mechanical information provided by this system will be used in conjunction with optical data to ensure optimum alignment.

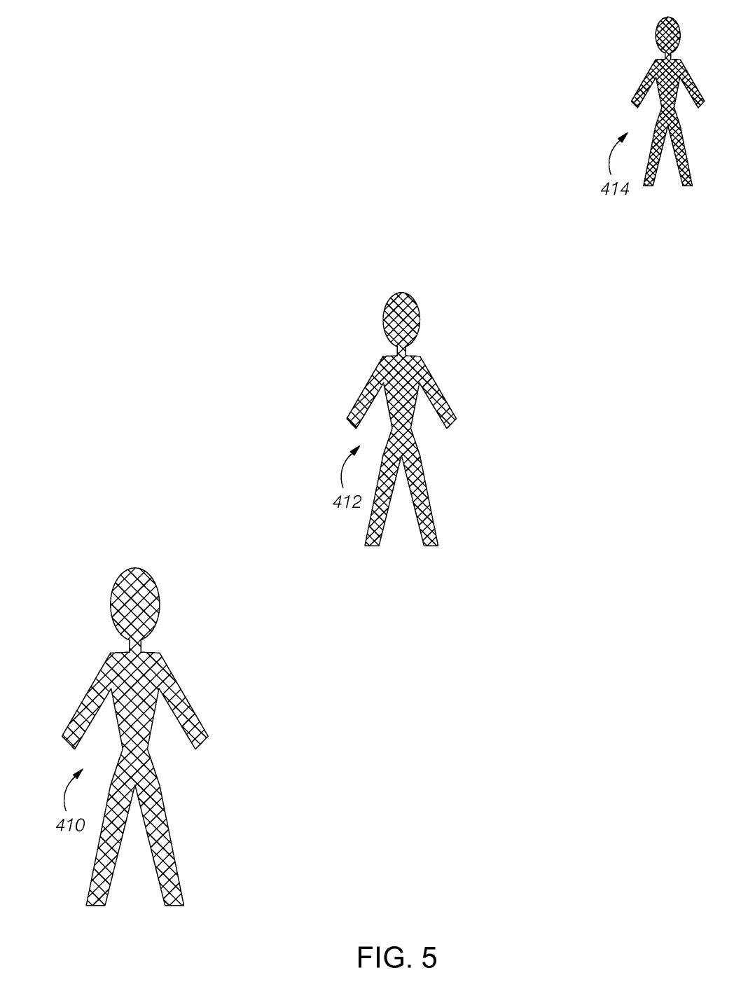

FIG. 5 illustrates a representation of an object 410 in the foreground, a correspondingly sized object 412 in the mid-ground and another correspondingly sized object 414 in the background in a mono-ocular imaging system. Due to the effects produced in optical image formation, objects closer to the taking lens generally appear larger than similar objects farther away.

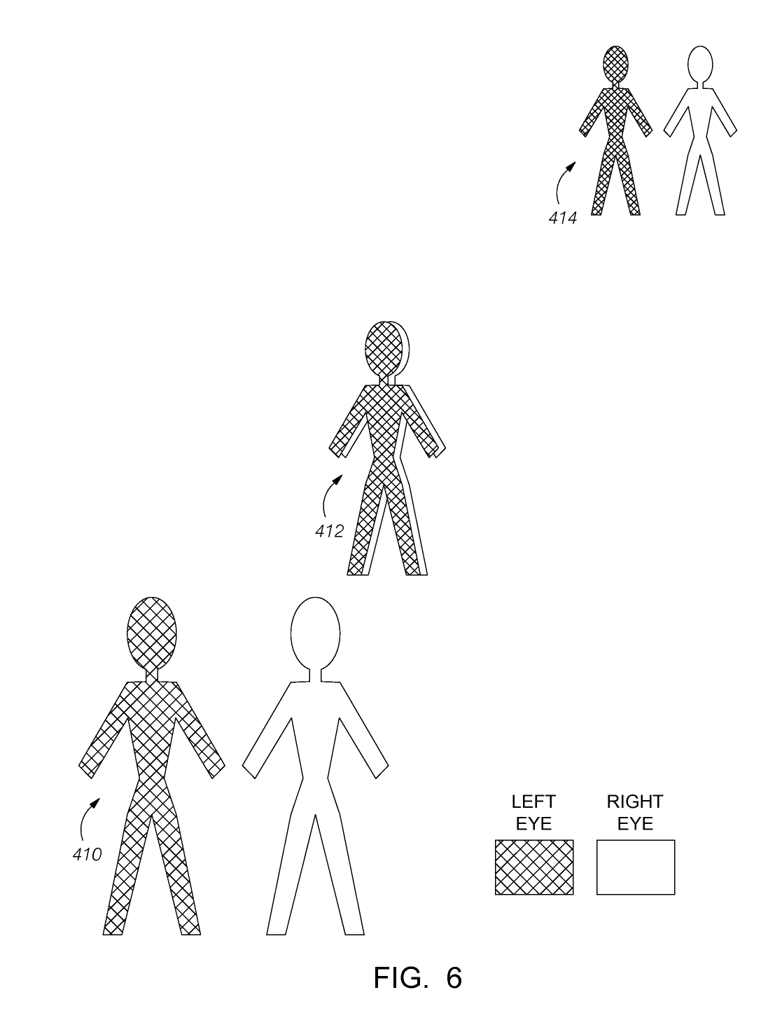

FIG. 6 illustrates a representation of the same objects 410, 412, 414 of FIG. 5, as seen in a stereo vision binocular system. In FIG. 6, the object in the mid-ground is at the nominal point of convergence of the imaging system, and that objects closer or farther away from the lens are in different relative positions in the left and right eye scenes. This property can be used to track the convergence point in a stereo video image capture system.

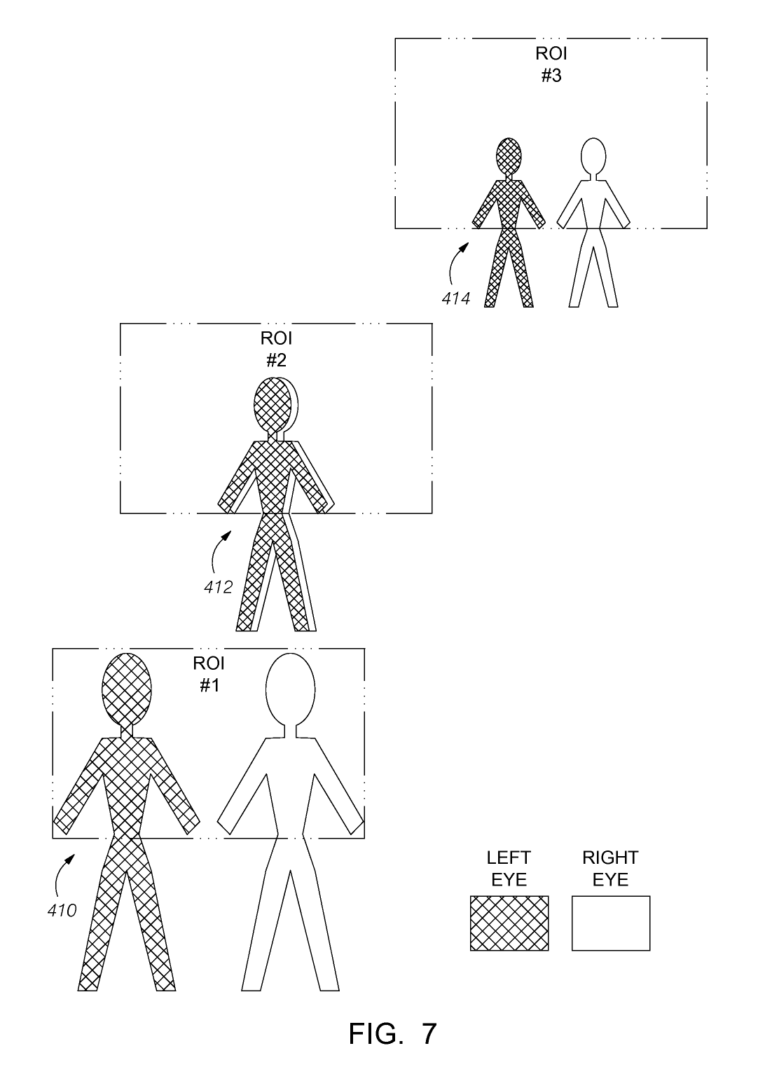

By measuring the amount of position difference between the left and right eye images in several regions of interest, as shown in FIG. 7, the point of optical convergence in the scene can be determined with great precision (based on the image sensor pixel size and lens characteristics). The position difference calculation in this approach can be based on edge-detection algorithms (e.g., using a Sobel filter) and uses optical flow methods to track the convergence point through multiple video frames.

In an exemplary embodiment of the method, a Sobel Edge Operator is first applied to each point in the selected regions of interest (ROI) in both the Right and Left eye images corresponding to an equivalent time period. The output of this operation produces edge intensity images for the respective ROIs. Next, the edge intensity images in the Right and Left eye ROIs are compared to determine which sets of edge images are correlated. An efficient and proven way of tracking features across multiple video frames has been described by Jiambo Shi and Carlo Tomasi in “Good Features to Track” and is illustrated in the attached “Appendix_Shi-Tomasi.”

When correlated sets of edge images are identified in the ROIs, the relative horizontal and vertical separation of these can be measured. As illustrated in FIG. 7, if the difference between the position of the blue (Left Eye) image edges and the red (Right Eye) image edges are positive (as in ROI #1), then the objects associated with those edges are identified as ‘Foreground’ objects. If the difference between the Page of position of the Left Eye image edges and the position of the Right Eye image edges are negative (as in ROI #3), then those objects are identified as ‘Background’ objects. Lastly, if the difference between the position of the Left Eye image edges and the position of the Right Eye image edges are zero or below a low threshold absolute value, then those objects are identified as in the ‘Convergence’ zone.

In this way, the objects in the convergence zone can be continually tracked by applying Sobel edge operators and motion tracking algorithms to consecutive video frame ROIs, and measuring relative position differences between correlated image edges.

In order to closely emulate the human eye, the rotation of lens assemblies must occur about the Nodal Points of the lens/sensor assemblies. One skilled in the art of optics will know that the Nodal Point of an image capture system is the point at which light rays converge in front of the image plane. If rotation does not occur about the Nodal Point, a multitude of optical disparities can occur. Such discrepancies will cause unpleasant side-effects in the viewer, such as nausea and head and eye pain.

The method by which the lens/sensor assemblies rotate about their respective Nodal Points is as follows. A combination of adjusting convergence angle and the inter-axial distance are utilized to trigonometrically achieve a Nodal Point rotation. Since the Inter-axial (inter-ocular) distance is known, the Nodal Point of the lens/sensor assemblies at any given setting can be determined using simple trigonometry.

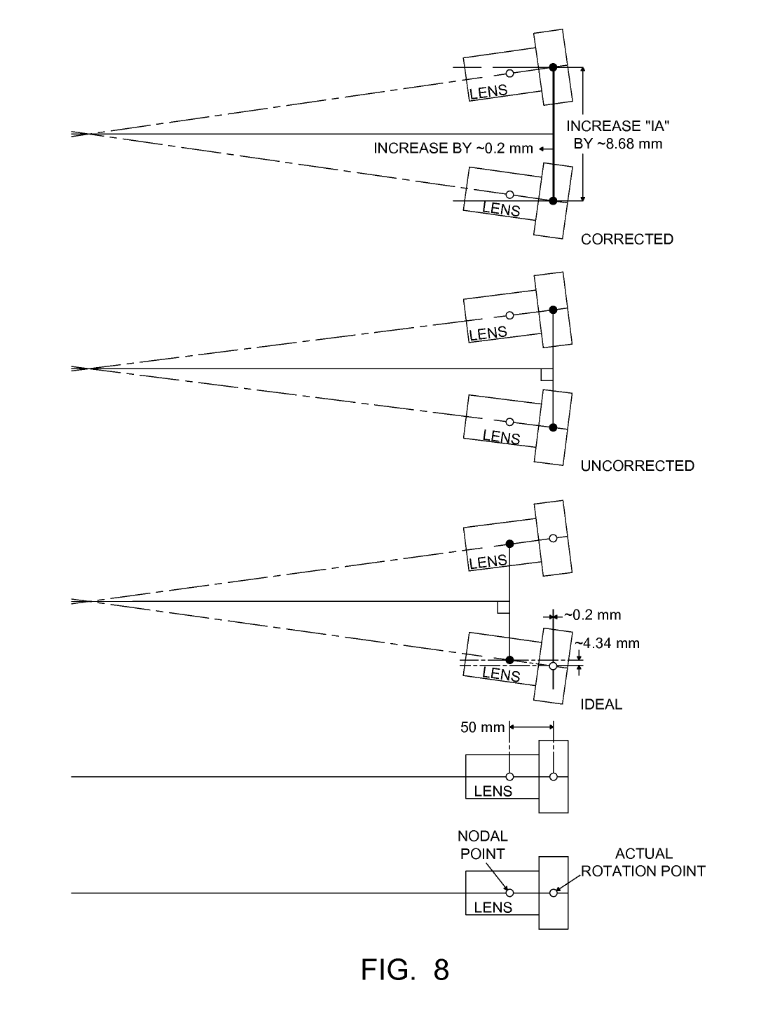

FIG. 8 illustrates the trigonometric relationship between the convergence angles and inter-axial distances of three configurations of stereoscopic imaging assemblies. The “Ideal” model shows the left and right lens/sensor assemblies rotating about their respective Nodal Points. As illustrated, the changes in the inter-axial distance and the slight translation of approximately 0.2 millimeter away from the plane of the Actual Point of Rotation. If the lenses are simply rotated about Actual Point of Rotation then an “Uncorrected” result is obtained. This can be corrected by adjusting the Interaxial distance, convergence angles and distance from the subject of the two lens/sensor assemblies to make an identical triangle to that illustrated in the “Ideal” model. This “Corrected” solution is trigonometrically equivalent to the “Ideal” solution and will decrease production costs that would be incurred by designing a rotation pivot at the actual nodal points of the lenses.

The translation towards the subject is very small and can be compensated for by a slight adjustment in focus. Subjectively, this difference may be so low as to be unnoticeable by the viewer and may not be included in production systems.

To effect a convergence rotation about the nodal point, the servo controls of inter-axial, convergence rotation and forward translation need to be coordinated. The parallax adjustment method is applied to all these servo mechanisms to ensure correct and precise convergence about the nodal point. This is an extension to the basic parallax method in which the servo loop controllers take into account the trigonometry involved in creating the rotation about the nodal point. So rather than simply rotating the lenses about the Actual Rotation point the error signal is fed into a calculation that applies the Pythagorean Theorem to create the rotation about the nodal point.

As the convergence of the lenses is changed, the focus and iris settings of the lenses may need to be changed. It is an operator selected function to leave the focus and iris settings untouched when changing convergence. This allows full artistic freedom for the camera user. However, it is also desirable to have the focus and iris track with the convergence. The desired focus point is often also the desired focus point. Also the iris, which affects the depth of focus, can be selectively tracked with the focus. For example, if the iris is left untouched then the furthest point in focus in a scene will shift as the convergence changes. This may be undesirable. If the focus and/or the iris need to track with convergence, they also receive the error signal.

As various changes could be made in the above constructions without departing from the scope of the invention, it is intended that all the matter contained in the above description or shown in the accompanying drawings shall be interpreted as illustrative and not in a limiting sense.

What is claimed is:

1. A stereoscopic camera system, comprising:
an enclosure;
a single lens support system mounted on the enclosure, the single lens support system supporting two lens assemblies, the two lens assemblies mounted on a common track and moveable by a single motor and a single double-threaded screw that moves the two lens assemblies in synchronism with respect to a centerline of the lens support subsystem to maintain the two lens assemblies at substantially equal distances from the centerline;
a lens supported by each lens assembly, each lens assembly being pivotable about a respective nodal point to direct each lens towards a target convergence point, each lens focusing an image onto a respective electronic image conversion system, each image conversion system generating a digitized image; and
an electronic storage system within the enclosure that stores the digitized images from each image conversion system in a single data storage stream.
